(19) United States
(12) Patent Application Publication
(10) Pub. No.: US 2004/0011977 A1
(43) Pub. Date: Jan. 22, 2004

(54) Micro-fluidic valves

(76) Inventors: Robert W Hower, Farmington Hills, MI (US); Hal C Cantor, Farmington Hills, MI (US); Jason R Mondro, Farmington Hills, MI (US)

Correspondence Address: Kenneth I Kohn, Kohn & Associates, Suite 410, 30500 Northwestern Highway, Farmington Hills, MI, 48334, US

(21) Appl. No.: 10/362,329

(22) PCT Filed: Aug. 31, 2001
(86) PCT No.: PCT/US01/27322

(51) Int. Cl. F16K 31/00

(52) U.S. Cl. 251/11

(57) ABSTRACT

According to the present invention, there is provided a micro-fluidic valve including a micro conduit for carrying fluid therethrough and at least one micro actuating mechanism for selectively deflecting at least a portion of a wall of the micro conduit occluding fluid flow through the micro conduit. Additionally, the present invention provides for a mono-stable micro-fluidic valve and for a bi-stable micro-fluidic valve.

### BACKGROUND OF THE INVENTION

1. Technical Field

The present invention relates to micro-fluidic valves for controlling nano or micro fluidic movement of fluid flow.

2. Background Art

An actuator that produces out of plane movement is necessary for many chip-scale (1 mm² to 1 cm²) applications. Some of these applications include: movement of small volumes of liquid using a micro-fluidic peristaltic pump, valving of solutions to deliver different chemicals to an area on a chip, mixing of solutions in a microscopic chamber, as well as through the attachment to other devices like cilia, fans, or other devices to produce out of plane motion for a silicon micro-machined chip.

Typically, actuators are the driving mechanism behind valves that selectively control the flow of fluid through a passageway, channel, port, or the like, in various micro-fluidic devices and systems. These actuators work by various types of actuation forces applied to a flexible mechanism, valve or other similar device. Actuation occurs through methods using various forces such as electrostatic, piezoresistive, pneumatic, magnetic, and thermal gas expansion.

Electrostatic actuation of a membrane is one of the fastest methods for valving solutions through a system. While these devices exhibit very fast actuation rates, they require very high voltages, from 100V to 200V.

Pneumatic actuation requires an external pressurized gas source to actuate the membranes that cause fluid valving. While this method is feasible in a laboratory setting where pressurized gas is available, it is impractical for in-the-field utilization.

Thermal gas expansion relies on the expansion of trapped air in the system to block fluid flow through conduits. This is accomplished by selectively producing hydrophobic and hydrophilic regions on the chip.

Valves can be produced by creating a constriction or reduced diameter segment within a conduit. Calibrated quantities of gases (i.e., air pockets) can then be introduced into the fluid containing conduit. The air is then displaced through the reduced diameter segment. This reduced diameter segment is often made to be hydrophobic to aid in aqueous solution valving properties. The air can then be forced through the reduced diameter segment, thereby producing a known volume droplet of aqueous medium.

Micro-fluidic valves can also be produced utilizing micro-machined flaps capable of covering a small orifice that preferentially allows fluid flow in one direction (i.e., a standard uni-directional flap-valve). Two of these are often placed in series to limit the flow of a pump to one direction. These “flap-valves” require a significant amount of micro-machining, and are not compatible with planar processes.

The devices from these previous bodies of work lack the ability to cost-effectively add integrated sensors or circuitry to the devices. Integrating circuitry incorporated into the micro-fluidic devices reduces: (1) the need for costly instrumentation, (2) the overall power consumption of the system, and (3) the complexity of the control signals and mechanisms. Additionally, integrated circuitry allows for the addition of chemical and physical sensor arrays, and for connection to telemetry systems for remote communication with external devices.

Most, if not all, of the micro-fluidic valves are used on structures that are not planar. (See, U.S. Pat. Nos. 5,962,081 and 5,726,404). Various other efforts are also underway to build miniature valves in silicon for micro-fluidics. It has been difficult to produce good sealing surfaces in silicon, and it turns out that these valves, although in principle can be mass-produced on a silicon wafer, they require expensive packaging to be utilized. Consequently, such micro-fluidic components cannot be considered inexpensive and/or disposable. In addition, these micro-fluidic valves should have the capability to be interconnected into systems including sensors, electronic controls, telemetric circuitry, and other devices such that the interconnection becomes expensive.

Accordingly, it would therefore be useful to develop a micro-valve that is miniature, mobile, planar, and overcomes the problems found in the prior art.

### SUMMARY OF THE INVENTION

According to the present invention, there is provided a micro-fluidic valve including a micro conduit for carrying fluid therethrough and at least one micro actuating mechanism for selectively deflecting at least a portion of a wall of the micro conduit occluding fluid flow through the micro conduit. Additionally, the present invention provides for a mono-stable micro-fluidic valve and for a bi-stable micro-fluidic valve.

### DESCRIPTION OF THE DRAWINGS

Other advantages of the present invention are readily appreciated as the same becomes better understood by reference to the following detailed description when considered in connection with the accompanying drawings wherein:

FIG. 1 is a schematic view of an embodiment of a mono-stable valve;

FIGS. 2A and B are schematic views of a bi-stable valve, where 2A is a top view of an embodiment of the bi-stable valve and 2B is a cross-sectional view of an embodiment of the bi-stable valve;

FIG. 3 is a picture of an embodiment of a flexible mechanism in an expanded position;

FIGS. 4A and B illustrate an embodiment of the mono-stable valve in a normally open and actuated closed state, respectively;

FIG. 5 graphically shows the temperature profile of wax cooling at different times; and

FIG. 6 graphically shows the temperature profile of wax heating at different times.

### DETAILED DESCRIPTION OF THE INVENTION

Generally, the present invention provides a micro-fluidic valve 22 including a micro conduit 20 for carrying fluid therethrough and at least one actuator mechanism 10 for selectively occluding fluid flow through the micro conduit 20.

The micro-fluidic actuators 10 can be utilized in at least two different modalities to provide a stable, open valve 21 and a stable open and closed bi-stable valve 23.

The terms “actuator” and “actuating mechanism” 10 as used herein are meant to include, but are not limited to, a device that causes something to occur. The actuator 10 activates the operation of the micro-fluidic valve of the present invention. Typically, the actuator 10 affects fluid flow rates within a chamber.

The term “closed cavity” 11 as used herein is meant to include, but is not limited to, a sealed cavity for enclosing a liquid or solid expanding mechanism 14 that is expanded or vaporized to generate expansion or actuation of a flexible mechanism 18. The cavity must be completely sealed in order to contain the expansion, and must be flexible on at least one side.

The term “expanding mechanism” 14 as used herein, is meant to include, but is not limited to, a fluid 14 capable of being vaporized and condensed within a closed cavity 11. The expanding mechanism 14 operates upon being actuated or heated. The expanding mechanism 14 includes, but is not limited to, water, wax, hydrogel, hydrocarbon, and any other similar substance known to those of skill in the art.

The term “flexible mechanism” 18 as used herein is meant to include, but is not limited to, any flexible mechanism 18 that is capable of expanding and contracting with the vaporization and condensation of the expanding mechanism 14. The flexible mechanism 18 must be able to stretch without breaking when the expanding mechanism 14 is vaporized. The flexible mechanism 18 is made of any material including, but not limited to, silicon rubber, rubber, polyurethane, PVC, polymers and any other similar flexible mechanism known to those of skill in the art.

The term “heating mechanism” 12 as used herein is meant to include, but is not limited to, a heating device or element 12 that is incorporated with the actuator 10 of the present invention. The heating mechanism 12 generates heat to induce expansion of the expanding mechanism 14. The heating mechanism 12 is disposed adjacently to the flexible mechanism 18 in order to turn on and off and maintaining on and off selective expansion of the expanding mechanism 14. Generally, the heating mechanism 12 is formed of materials including, but not limited to, polysilicon, elemental metal, silicide, or any other similar heating elements known to those of skill of the art.

Typically, the heating mechanism is encased in a medium such as SiO₂. The heating mechanism 12 can be powered using any power source known to those of skill in the art, but requires very low power to achieve sufficient temperatures for vaporization of the expanding mechanism 14. It is necessary to utilize low power devices and circuitry to conserve energy and allow the use of very small, lightweight film, or button batteries.

The term “temperature sensor” 16 as used herein, is meant to include, but is not limited to, a device designed to determine and monitor temperature. The temperature sensor 16 is made from material including, but is not limited to, polysilicon, elemental metal, silicide, thermister, thermocouples, and any other similar material known to those of skill in the art. Typically, the temperature sensor 16 is situated within or near the heating element of the heating mechanism 12. The temperature sensor 16 ensures that the heating mechanism 12 is maintained within proper parameters as determined by one skilled in the art. A resistive temperature sensor 16 can be formed of polysilicon, elemental metal, or silicide; however, other materials and methods known to those skilled in the art for producing temperature sensors (i.e., thermocouples).

The terms “chamber,” “micro chamber,” “pulsating micro chamber,” “micro conduit,” and “conduit” as used herein are meant to include, but not limited to, any type of tube, pipe, planar channel, conduit, or any other similar chamber known to those skilled in the art. The conduit has a wall mechanism made from material including, but not limited to, glass, silicon, rubber, silicone, plastics, polymers, metal, and any other similar material known to those of skill in the art. In one embodiment of the micro fluidic valve, the chamber encompassing the micro-actuator is etched out of glass in a nearly hemispherical shape. A variety of conformations of spherically cut patterns (i.e. ⅓ of a sphere, ½ of a sphere, etc.) with differing radii and footprints are employed to provide different valving characteristics.

In any embodiment, the valves of the present invention utilize an actuating mechanism 10 to occlude a micro conduit 20 and thereby decreasing or preventing fluid flow. The ability to occlude is selective, in that the valve can effectively open and close a passageway of the micro conduit. The micro fluidic actuators 10 are the driving mechanism behind the micro-fluidic valves 22 of the present invention.

The micro-fluidic valve 22 has various pressures and temperatures required for its actuation. The valve 22 can be selectively controlled and actuated through an integrated CMOS circuit or through computer control, which controls actuation timing, electrical current, and heat generation/dissipation requirements for actuation. Integration of control circuitry is important for reduced power requirements of the present invention. In one particular embodiment for example, sensors and circuitry responsible for monitoring the effluent of a fuel cell, with concomitant control of the micro-fluidic fuel delivery system to increase or decrease the flow rate of fuel, is designed. This ensures optimal fuel utilization in the device. Closed loop feedback provides the basis of automated adjustment of circuitry and therefore, valving, within the micro actuator.

In one embodiment of the present invention, the actuator 10 includes a closed cavity 11, flexible mechanism 18, and expanding mechanism 14. Fabrication of actuators 10 is accomplished by generating optical and/or electron-beam (e-beam) masks from the CAD designs of the micro-fluidic system. Then, using solid-state mass production techniques, silicon wafers are fabricated and the flexible mechanisms 18 for the actuators 10 subsequently are placed on the chips.

In the device without integrated circuitry, the control circuitry is produced on external breadboards and/or printed circuit boards. In this manner, the circuitry is easily, quickly, and inexpensively optimized prior to miniaturization and incorporation as CMOS circuitry on-chip that can be controlled manually, or through the use of a computer with digital and analog output. Optimized CMOS circuitry, modeled utilizing T-Spice pro (Tanner, Calif.) solid state MEMS and CMOS design and simulation tools, is integrated into the active device making it a stand-alone functional unit.

Electronic control of the actuators 10 is optimized to maximize valving forces and minimize power utilization and heat generation. An e-prom is also included on-chip to provide digital compensation of resistors and capacitors to compensate for process variations and, therefore, improve the process yield. Electrical access/test pads are designed into the chips to allow for the testing of internal nodes of the circuits.

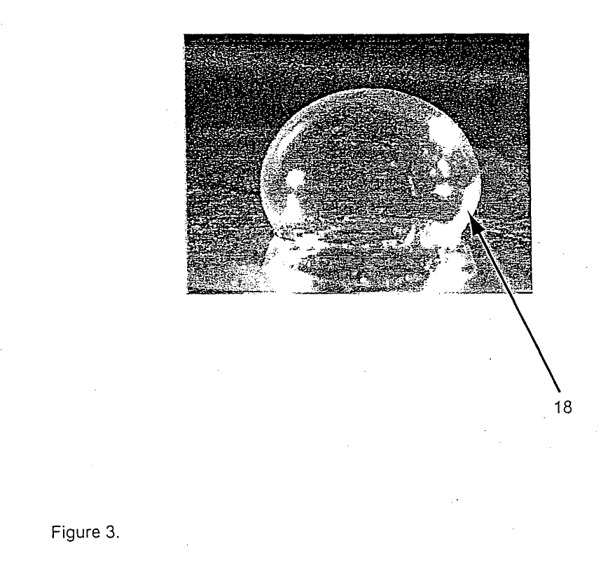

The flexible mechanism 18 deflects upon the application of pressure thereto. The flexible mechanism 18 is screen-printed over the expanding mechanism 14 utilizing an automated screen-printing device, a New Long LS-15TV screen printing system. The flexible mechanism 18 is very elastic and expands many times its initial volume as the expanding mechanism 14 under the flexible mechanism is vaporized (FIG. 3). Due to the large deflection, it is possible to completely occlude a micro-channel with this flexible mechanism 18, hence providing the functionality of an electrically actuated microscopic valve. The present invention can also apply the flexible mechanism 18 with syringe or pipette devices or spin coat it on the entire wafer. A photo curable membrane can also be used to pattern the flexible mechanism 18 on the wafer.

A wide variety of commercially available polymers can be utilized as the flexible mechanism 18, including, but not limited to: Polyurethane, PVC, and silicone rubber. The actuator flexible mechanism 18 must possess elastomeric properties, and must adhere well to the silicon or other substrate surface. A material with excellent adhesion to the surface, as well as appropriate physical properties, is silicone rubber.

In an embodiment of the present invention, the flexible mechanism 18 is made of silicone rubber. The silicone rubber can be dispensed utilizing automated dispensing equipment, or can be screen-printed directly upon the silicon wafer. Screen printing methods have the advantage that the entire wafer, containing hundreds of valve actuators 10, can be produced at once. By varying the amount of solvent in the silicone rubber, the flexible mechanism 18 thickness can be precisely controlled.

The flexible mechanism 18 can serve the dual purpose of actuation as well as serving as the bonding material used to attach the liquid flow channels to the silicon chip containing the actuators 10. By covering the entire area of the chip with the flexible mechanism 18, with the exception of the sensing regions and the bonding pads, the glass or plastic channels can be “glued” to the actuator 10 containing silicon chip. This method provides additional anchoring and strength to the actuation flexible mechanism 18, and allows the actuation area to encompass the entire actuation chamber 20. The only drawback to this method is protein and/or steroid adsorption onto the micro fluidic conduits. However, with proper flexible mechanism 18 selection, and chemical treatment, molecular adsorption can be minimized, or a second, thin, inert layer can be used to coat the flexible mechanism 18.

The expanding mechanism 14 selectively expands the cavity 11 defined by the flexible mechanism 18 thereof and thereby selectively flexes the flexible mechanism 14. The expanding mechanism can be made of various materials. In one embodiment, the expanding mechanism is a hydrogel material, which contains a large amount of water or other hydrocarbon medium, which is vaporized by the underlying heating mechanism. In this embodiment, the volume of hydrogel needed to produce the desired actuation and pressure for the flexible mechanism 18 is approximately 33 pL. With this design, approximately 97% of the energy generated by the heating mechanism 12 is transferred into the hydrogel for evaporation.

The gaseous or liquid fluid being valved serves the purpose of acting as a heat sink to condense the vapor back to liquid and hence return the flexible mechanism 18 to its relaxed state when the heating mechanism 12 is inactivated. A temperature sensor 16 is integrated adjacent to the actuator 10 to monitor the temperature of the micro-fluidic integrated heating mechanism 12 and hence, expanding mechanism 14.

The heating mechanism 12 requires very low power to achieve sufficient temperatures for fluid vaporization. As an example, miniature inkjet nozzles that require temperatures in excess of 330° C., utilize 20μ second pulses of 16 mA to heat the fluid and fire an ink droplet. Considerably lower power would be required to vaporize the liquid in the present micro-fluidic pump application. In the field, it is necessary to utilize low power devices and circuitry to conserve energy and allow the use of very small, lightweight, film or button batteries.

Once the heating mechanism 12 is activated, vaporization of the expanding mechanism 14 takes place. The expanding mechanism 14 component imposes a pressure upon the flexible mechanism 18 causing it to expand and be displaced above the heating mechanism 12 and reduce the volume of the chamber 20. This methodology can be utilized to occlude fluid flow through the chamber 20 (valving action, see FIG. 3).

The heat flux through each of the layers composing the device is calculated using existing boundary conditions. The temperature required to vaporize the expanding mechanism 14 varies according to the physical and chemical properties of the expanding mechanism 14 itself. Due to the differences in heat transfer through liquid versus gas, approximately twice as much heat flux travels through the device when the hydrogel is all liquid compared to all vapor. In order to reduce heat dissipation into the medium being valved, while the hydrogel is in the liquid state, the heating mechanism 12 is quickly ramped to the temperature required to vaporize the liquid. Once the hydrogel is vaporized, heat transfer to the medium being valved is minimized.

For the mono-stable valve, It is assumed that the temperature on both sides of the SiO₂ that encapsulates the heating mechanism 12 is constant, and that heat flux in each direction is dependent upon the heating mechanism 12 temperature and the resistance to heat flow either through the device or to the air from the backside. In order to isolate the heater, a cavity is etched in the backside of the wafer, providing thermal isolation.

In one embodiment, the temperature of the saturated liquid hydrogel, at 1 ATM, is assumed to be 100° C. The heat flux to the air, through the back of the heating mechanism 12, is calculated to be 1263 W/K-m². The total is heat flux through the device is calculated to be 46,995 W/K-m² with a total flux from the heating mechanism 12 of 47,218 W/K-m² (i.e. 97% efficiency of focused heat transfer). In this embodiment, the temperature of the inactive state hydrogel varies between 86 and 94 C.

The temperature of the activated, vapor state hydrogel is approximately 120° C., which is the saturation temperature for steam at 2 ATM. The heat transfer coefficient for convection can be calculated directly from the thermal conductivity. The heat flux to the air through the back of the heating mechanism 12 is 2818 W/K-m². The heat flux through the device is 21,352 W/K-m² with a total flux from the heating mechanism 12 of 24,170 W/K-m². When the aqueous component of the hydrogel is completely in the vapor state, there is no fluid 14 in the channel and the thin film of solution between the flexible mechanism 18 and the glass is approximately at 60° C. These values and calculations vary according to the type of valve being used.

The temperature distribution through each layer of the device is modeled using linear methods. The actual temperature distribution is exponential, but the temperatures at the interface of each layer are identical to that predicted by the linear model.

In an embodiment of the present invention, the volume of liquid hydrogel is determined based on the volume of vapor needed to expand the flexible mechanism 18 completely at, 2 ATM, using the ideal gas law. This assumption is valid because the temperatures and pressures are moderate. The volume of liquid hydrogel necessary to achieve this volume of gas at this pressure, assuming the hydrogel is 10% water and all of the water is completely evaporated, is 0.033 nL. Cylindrically shaped sections of hydrogel are utilized within the actuator 10. This shape has been chosen to optimize encapsulation by the actuator flexible mechanism 18. The cylinders have either a diameter of approximately 140 μm and a height of 2.14 μm, or a diameter of 280 μm with a height of 0.54 μm (identical volumes, different orientation to the heating element). Of course, the shapes and volumes vary according to the type of expanding mechanism being used. For example, photocurable liquid hydrogels have different parameters.

For flexible mechanism 18 actuation and hydrogel vaporization, it is necessary to raise the temperature of the hydrogel from ambient temperature to the boiling point, 120° C. at 2 ATM. Thermodynamic models indicate that approximately 8.03×10⁻⁷ J of heat transfer is required to raise the temperature of the hydrogel from 37° C. to 120° C. (1.08×10⁻⁷ J) and vaporize all of the water (6.95×10⁻⁷ J). This is consistent with the sum of enthalpy equation.

In another embodiment, for flexible mechanism 18 contraction and hydrogel condensation, it is assumed that all heat dissipation from the activated, vaporized hydrogel, as it condenses, is transferred into the gaseous or liquid solution being valved. The calculation for this condensation involves condensing all of the water in the hydrogel plus sub cooling the hydrogel from 100° C. to 90° C. in order to completely contract the actuator 10. Modeling conduction through the actuator 10 flexible mechanism 18 using Fourier's equation provides a flux of 0.0015 J/s and a condensation time of 0.00473 seconds. This represents a worst case scenario, neglecting thermal conduction to the silicon substrate.

In an embodiment of the present invention, the heating mechanism 12 is laid out as a square that encompasses the majority of the circular hydrogel area without extending past the edge of the chamber 20. Other shapes are also employed, such as circular and triangular layouts, to encompass as much of the hydrogel as possible. In order to provide efficient micro-actuation in 150 μs, requirements for the heating mechanism 12 power input/output and electrical resistance are calculated. To provide the required 777 nJ of energy, the resistance of the poly-silicon heating mechanism 12 is calculated to between 450 to 500Ω, based upon utilizing a 5V power supply. Actuation requires a 150 μs pulse of approximately 11 mA of current, providing the 777 nJ of energy required. In previous work, poly-silicon structures at a thickness of 6000 Å, having a resistance of 15 Ω/elemental square have been produced. To provide the required resistance, 5 poly-silicon heating mechanism 12 lines are arranged in parallel. The poly-silicon heating mechanism 12 elements have a width of 5 μm. The total resistance of the heating mechanism 12 is 450 Ω.

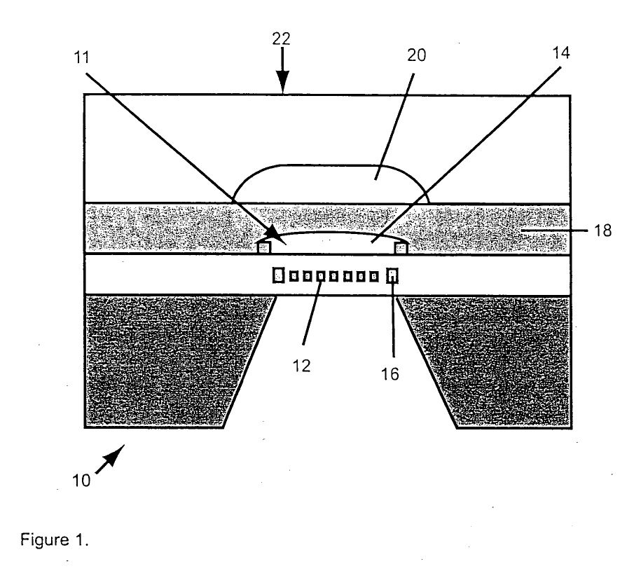

FIG. 1 is a schematic layout of an actuator 10 and heating mechanism 12. In this case, the heating mechanism 12 is poly-silicon, but can be any similar material. Because of its high thermal conductivity, the silicon substrate acts as a heat sink. To reduce thermal conduction to the silicon substrate, a window in the silicon, located beneath the heating mechanism 12, provides the hydrogel with an isolated platform. This window is only slightly larger than the heating mechanism 12 to maintain some thermal conduction to the substrate. After the actuator 10 is energized, thermal conduction to the silicon provides decreased time to condense the liquid in the hydrogel. This decreased constriction time provides improved valving rates. If the window is significantly larger than the actuator 10, there is no heat conduction path to the substrate, hence increasing condensation time and decreasing the valving rate.

In one embodiment, the hydrogel is presented as a cylinder with diameter of 280 μm and height of 0.5-1 μm. The actuation chamber 20 encompasses the entire-cavity etched in the glass substrate. The cavity can be redesigned before mask generation to account for undercut of the glass. As glass is chemically etched, the etchant undercuts the mask making the cavity larger than the photo mask size.

Fabrication of this device is based upon the development of a process flow. The fabrication process utilizes bulk silicon micro-machining techniques to produce the isolation windows, and thick film screen printing techniques, spin coating, mass dispensing, or mechanical dispensing of actuation membranes.

A polymeric hydrogel (or hydrocarbon) can be utilized to provide a physically supportive structure that withstands the application of flexible mechanism 18 as well as to provide the aqueous component required for actuation. Several commercially available materials meet these requirements. A hydrogel is selected that contains approximately 30% aqueous component that vaporizes near 100° C. Several promising materials have been identified, each of which is examined for suitability in this application, including, but not limited to, hydroxyethylmethacrylate (HEMA) and polyvinylpyrrolidone (PVP). Additionally, hydrocarbons can be used since they possess lower boiling points than aqueous hydrogels, and therefore require less power to effect pneumatic actuation.

Dispensing hydrogel (or hydrocarbon) into the desired location is accomplished utilizing one of three methods. First, a promising method for patterning the hydrogel is to utilize a photopatternable-crosslinking hydrogel. The hydrogel is cross-linked by incorporating an UV photo-initiator polymerizing agent within the hydrogel that cross-links when exposed to UV radiation. Using this technique, the hydrogel would be evenly spun on the entire wafer using standard semiconductor processing techniques. A photographic mask is then placed over the wafer, followed by exposure to UV light. After the cross-linking reaction is completed, excess (non-cross-linked hydrogel) is washed from the surface.

The second method involves dispensing liquid hydrogel into well-rings created around the poly-silicon heating mechanism 12. These wells have the ability to retain a liquid in a highly controlled manner. Two photopatternable polymers have been utilized to create microscopic well-ring structures, SU-8 and a photopatternable polyimide. These well-rings can be produced in any height from 2 μm to 50 μm, sufficient to contain the liquid hydrogel. Once the hydrogel solidifies, flexible mechanisms can be deposited over them. This can be accomplished in an automated manner utilizing commercially available dispensing equipment.

In a third alternate method, a pre-solidified hydrogel is used that has been cut into the desire size and shape. This is facilitated by extruding the hydrogel in the desired radius and slicing it with a microtome to the desired height, or by spinning the hydrogel to the desired thickness and cutting it into cylinders of the desired radius. Utilizing micro-manipulators, the patterned gel is placed in the desired area. This process can also be automated.

It is assumed that the temperature on both sides of the SiO₂ that encapsulates the heating mechanism is constant, and that heat flux in each direction is dependant upon the poly-silicon heating mechanism temperature and the resistance to heat flow either through the device or to an air pocket on the heating mechanism backside. A schematic of a cross section of the actuator device is provided. Steady-state heat flow through the entire actuator, for the fully actuated state, the intermediate state, and the resting state are modeled. This data is calculated for the static case during which time no fluid flow is occurring and the valve is unactuated (i.e. steady-state; the system is poised at 100 C., waiting to be initiated). The fluid temperature is greater for the contracted state since the liquid hydrogel conducts heat at a greater rate than when in the vapor state.

In one embodiment, a mono-stable valve 22 requires continuous power to maintain a closed-stated position. Utilizing the heating mechanism 12, an expanding mechanism 14 is vaporized under the encapsulating flexible mechanism 18 thereby providing the pneumatic driving force required to expand the flexible mechanism 18 and hence occluding the micro conduit 20.

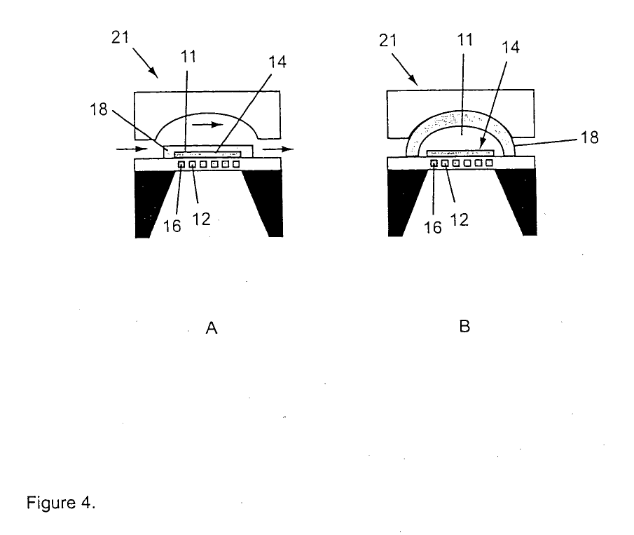

The mono-stable, normally open valve utilizes a single actuator to effectively actuate the valve. As the hydrogel is expanded, the silicone rubber of the actuator completely occludes the micro-fluidic channel to effect valving of the solution. Schematics of the mono-stable valves are presented in FIGS. 1 and 4. While the normally open valve is less complicated to construct, it requires continuous power or pulsed power to keep the valve closed.

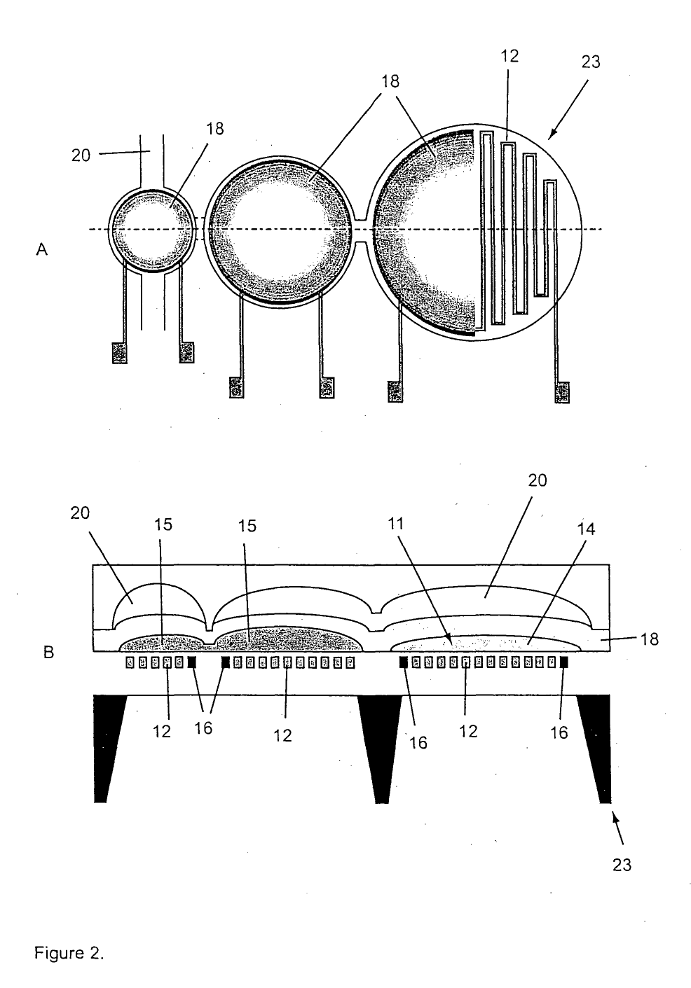

In another embodiment of the present invention, a bi-stable valve is designed that utilizes lower power consumption for valves that remain in the same state for long periods and a wax material to provide passively open and passively closed functionality, i.e. bi-stability. Thus, power is only required to transition from one state to the other. The bi-stable valve design is based upon the utilization of a moderate melting point solid, such as paraffin wax, which possesses a melting point between 50 and 70 C. FIG. 2a shows a top view and 2b shows a cross-section of the bi-stable valve in the open state. The two actuators on the left, which contain the paraffin wax, are connected to each other by a fluid conduit.

The bi-stable valve 23 similarly utilizes actuating mechanisms 10, 15 to occlude the micro conduit 20. The mono-stable valve can only provide the functionality of a normally open valve. During the period that the valve 23 must be maintained in a closed position, continuous power, must be applied. In this embodiment, there is a bi-stable valve 22 that utilizes micro-fluidic actuators 10, 15 to provide both zero-power open and closed functionality.

As previously mentioned, the bi-stable valve utilizes a total of three micro-fluidic actuating mechanisms 10, 15. Although, any number of actuating mechanisms 10, 15 can be used without departing from the spirit of the present invention. Two actuating mechanisms 15 are physically connected by a micro-fluid conduit formed under the membrane, and are filled with a low melting point solid such as paraffin wax as opposed to an aqueous hydrogel 14 (see above for mono-stable actuation). The third is a standard design micro-actuator 10 filled with an aqueous hydrogel connected by the expansion chamber to the middle wax filled actuator. The first two micro-actuators 15 are activated causing the wax to melt. The third, standard, micro-actuator 10 is then activated, providing pneumatic force on the wax containing actuators 15, causing the orifice containing chamber 20 to close. The wax is then allowed to solidify. Again, the advantage of this valve 22 is that it requires power only to transform from the stable open to the stable closed state.

In the open state, medium in the channel readily flows. To switch from the open state to the closed state, the wax is melted and the pneumatic actuator on the right is expanded. This creates pressure outside the middle actuator, forcing the paraffin into the smaller left chamber, expanding the membrane, thereby blocking fluid flow. The wax is allowed to solidify, after which the power can be removed from the actuator providing the driving force pressure, resulting in an electrically passive closed state. To transition from the closed state to the open state, the wax is melted and membrane tension forces the wax from the small left chamber back into the middle chamber. The micro-valve design provides bi-stable functionality, which only requires power to switch between each state, but is completely passive once in either the open or closed position.

Actuation of the micro-fluidic bi-stable valve entails melting of a paraffin wax beneath an actuating membrane, and using pressure to force it into a hemispherical chamber to occlude a fluidic channel, hence closing the valve. The hydrogel-based actuator provides the pressure. After the wax is allowed to cool, the valve remains closed without external power. To open the valve, the wax is again melted allowing it to re-flow into its original position, forced by tension on the expanded valving membrane. To calculate time required for melting and solidifying of the wax, certain assumptions are made.

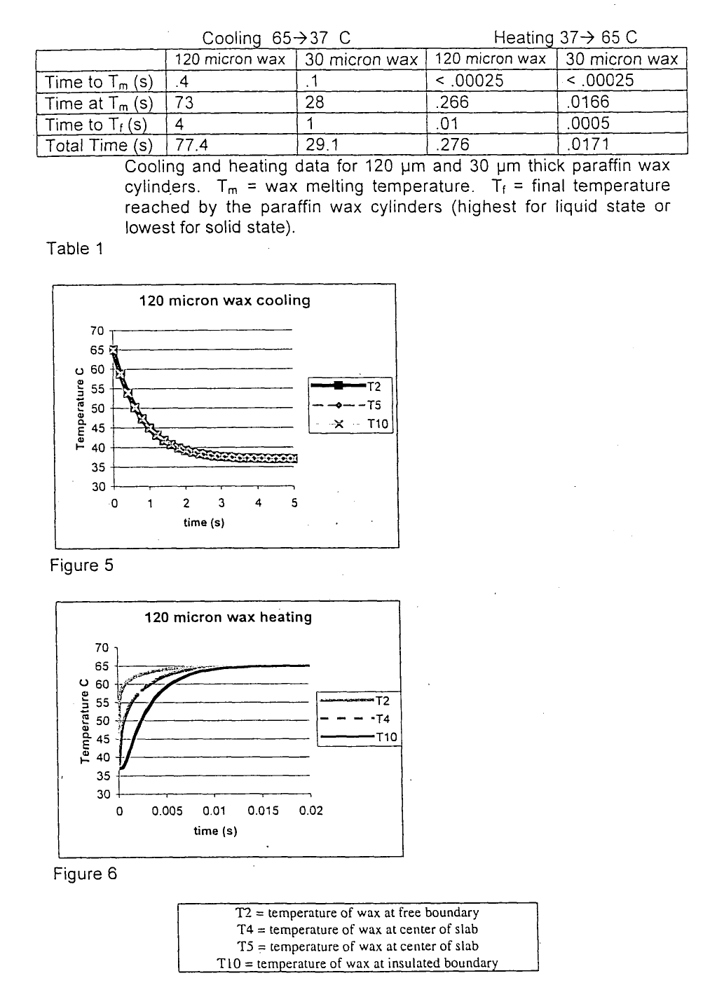

The time to heat and cool the wax in the bi-stable valve is calculated using Fick's equation for unsteady-state heat transfer. The partial differential equation is reduced to solving simultaneous ordinary differential equations using numerical methods of lines with Polymath Software. Curves from the cooling and heating time calculations are shown in FIGS. 5 and 6, respectively, and presented in tabular format in Table 1.

To calculate the unsteady-state heating and cooling, it is necessary to assume an insulated boundary at one side of the wax and either a convective (cooling) or a conductive constant temperature (heating) boundary at the other side. The assumption of the insulating boundary is appropriate for the 400 μm radius middle wax chamber since there is a pocket of air on the other side of the membrane that is in contact with the wax. This can be approximated as an insulated boundary.

In one embodiment, three actuators are needed for implementation of the bi-stable valve. Wax is contained in the small actuator in the left chamber, which is in the shape of a hemisphere with radius of 140 μm and a height of 20 μm when the valve is open and a height of 120 μm when the valve is closed. The middle chamber has a radius of 400 μm and a height of 30 μm when the valve is open, and when closed, the wax is be forced into the small chamber leaving a height of 20.25 μm. Using these dimensions to calculate the volume of wax in each chamber yields 1.23 nL of solid wax in the small chamber and 15 nL of solid wax in the middle chamber with the valve open (i.e. membranes relaxed).

The insulating assumption used for the small 120 μm wax slab, in the expanded valve, which blocks the fluid channel, is a conservative assumption and provides a maximum cooling time using only a convective boundary on one side of the wax. A more realistic estimate is similar to that of the constant temperature boundary condition, with the flowing solution in the channel as the constant temperature sink. The speed at which the wax is forced into the channel, thereby closing the valve, affects cooling time of the wax. When the valve is closed slowly, the flowing solution in the channel absorbs heat from the wax, thereby reducing cooling time. If the valve is closed quickly, heat from the wax is not able to be transferred to the solution, hence increasing cooling time.

The time required to heat the wax is significantly shorter than that required to cool the wax. This is true since heating uses a constant temperature source at the boundary (an embedded poly-silicon or other type of heater) without thermal resistance to the wax, and the cooling calculations utilized a high thermal convective resistance (air).

It is important to consider expansion and contraction of the wax during heating and cooling: slower cooling rates combined with the use of a lower melting point wax can reduce shrinkage of the wax after it has occluded the channel. To eliminate problems with shrinkage and thermal breakdown, the wax should not be heated to a temperature greater than that necessary for it to liquefy. For a typical paraffin wax, the temperature should be kept below 65 C. to prevent oxidation. Paraffin wax has a melting point of 60 C. and a congealing point of 59 C., therefore the temperature range of phase transition is narrow, thereby providing a uniform temperature distribution and uniform melting. Other types of waxes have a wider temperature range of phase transition that can be used for other temperature range applications.

The thermal shrinkage of the wax is important because too much shrinkage would allow the valve to open slightly, thereby allowing solution to pass. Based upon the densities of melted and solidified wax, the contraction of the wax in the device is calculated to be approximately 9 percent. This can be compensated for by utilizing methods to force more wax into the chamber to prevent this shrinkage. Additionally, a slower cooling rate applied to the wax reduces shrinkage. Another method to compensate for shrinkage involves cooling the left, valving chamber while the middle and right chambers remain heated. This forces more wax into the valving chamber as the wax cools. The power required to melt the wax is also important to consider and minimize. The calculated steady-state heat flux through each wax slab in the device is calculated to be approximately 550 W/m².

In one embodiment, to calculate the pressure required to actuate the valving membrane, the overlap between the two chambers with wax-based actuators is estimated to be approximately 200 μm wide. Using the thickness of the wax in the small valving chamber, the height is calculated to be 20 μm. The pressure required to push melted wax through a 200 by 20 μm channel, modeled as parallel plates, is 0.06 ATM or 0.9 psi, a readily obtainable pressure.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A micro-fluidic valve comprising:
a micro conduit for carrying fluid therethrough; and
at least one micro actuating means for selectively deflecting at least a portion of a wall of said micro conduit occluding fluid flow through said micro conduit.

2. The micro-fluidic valve according to claim 1, wherein said actuating means includes a closed pocket adjacent to said micro conduit, flexible means defining a portion of a wall of said pocket, and expanding means for expanding a volume of said pocket and thereby flexing said flexible means into said micro conduit thereby by selectively occluding the flow of fluid through said micro conduit.

3. The micro-fluidic valve according to claim 2, wherein said expanding means is selected from the group consisting essentially of water, wax, hydrogel, and hydrocarbon.

4. The micro-fluidic valve according to claim 2, wherein said valve is a mono-stable valve wherein said actuating means further includes heating means for selectively and continuously inducing expansion of said expanding means into said micro conduit thereby continuously occluding the flow of fluid through said micro conduit.

5. The micro-fluidic valve according to claim 4, wherein said mono-stable valve includes a normally open position thereby allowing fluid flow and an actuated closed condition thereby occluding fluid flow through said micro conduit.

6. The micro fluidic valve according to claim 2, wherein said mono-stable valve includes a partially open position, whereby said open position is controlled by said actuating means.

7. The micro-fluidic valve according to claim 2, wherein said mono-stable valve is produced utilizing low temperature, planar fabrication techniques.

8. The micro-fluidic valve according to claim 1, wherein said valve is a bi-stable valve including three actuating means.

9. The micro-fluidic valve according to claim 8, wherein two of said actuators are connected by a micro-fluid conduit.

10. The micro-fluidic valve according to claim 8, wherein said actuating means includes a closed pocket adjacent to said micro conduit, flexible means defining a portion of a wall of said pocket, and expanding means for expanding a volume of said pocket and thereby deflecting said flexible means into said micro conduit thereby by selectively occluding fluid flow through said micro conduit.

11. The micro-fluidic valve according to claim 10, wherein at least two said actuating means includes expanding means made of wax.

12. The micro-fluidic valve according to claim 11, wherein said actuating means includes an zero power closed condition and a zero power open condition thereby creating a bi-stable valve.

13. The micro-fluidic valve according to claim 10, wherein at least one said actuating means includes expanding means made of material selected from the group consisting essentially of water, hydrogel, and hydrocarbon.

14. The micro fluidic valve according to claim 8, wherein said bi-stable valve includes a partially open position, whereby said partially open position is controlled by said actuating means.

15. The micro fluidic valve according to claim 8, wherein said bi-stable valve is produced utilizing low temperature, planar fabrication techniques.
